(19) United States
(12) Patent Application Publication
(10) Pub. No.: US 2019/0205904 A1
(43) Pub. Date: Jul. 4, 2019

(54) INFORMATION-PROCESSING DEVICE, DATA ANALYSIS METHOD, AND RECORDING MEDIUM

(71) Applicant: NEC Corporation, Tokyo (JP)

(72) Inventor: Akiko OSHIMA, Tokyo (JP)

(73) Assignee: NEC Corporation, Tokyo (JP)

(21) Appl. No.: 16/297,969

(22) Filed: Mar. 11, 2019

Related U.S. Application Data
(63) Continuation of application No. 15/119,460, filed on Aug. 17, 2016.

(30) Foreign Application Priority Data
Feb. 25, 2014 (JP) 2014-034036

(51) Int. Cl. G06Q 30/02; G06K 9/00

(52) U.S. Cl. CPC G06Q 30/0201; G06K 9/00; G06Q 30/02; G06K 9/00771

(57) ABSTRACT

An information-processing device according to the present invention includes: a person detection and tracking unit that receives analysis information related to positions of persons in a target area, and calculates first person's-tracking-information; a same person detection unit that specifies the persons related to the first person's-tracking-information, classifies the first person's-tracking-information of the persons, and calculates second person's-tracking-information of a position of the persons; a direction calculation unit that calculates movement direction information of the persons based on the second person's-tracking-information; a staying time calculation unit that calculates staying-place information and staying-time information of the persons based on the second person's-tracking-information; and a processing unit that calculates trajectory information and staying information of the persons based on the movement direction information, the staying-place information, and the staying-time information.

The present application is a Continuation application of Ser. No. 15/119,460 filed on Aug. 17, 2016, which is a National Stage Entry of PCT/JP2015/000779 filed on Feb. 19, 2015, which claims priority from Japanese Patent Application 2014-034036 filed on Feb. 25, 2014, the contents of all of which are incorporated herein by reference, in their entirety.

### TECHNICAL FIELD

The present invention relates to analysis of data, and particularly to an information-processing device analyzing, a data analysis method, and a recording medium which analyze behavior information of a person.

### BACKGROUND ART

Recently, to grasp a purchasing trend of customers or examine efficiency improvement of employee's work, an information-processing device that analyzes behavior information of a person has been used. The information-processing device analyzing the behavior information, for example, uses image information of a monitoring camera, information from a radio frequency identification (RFID) tag, and information (e.g., the number) of a subscriber identity module (SIM) card of a cellular phone. Based on these pieces of information, the information-processing device calculates behavior trajectory information of a person (e.g., refer to PTL 1). The calculated person behavior trajectory information is used in analysis of behavior of the person in an area in a store or a warehouse, for example. An analysis person who analyzes behavior can grasp, based on the person behavior trajectory information, information effective in purchasing behavior or work efficiency improvement.

In the future, data concerning a person will further expand (become big data). Such a social environment is creating an increasing demand for the provision of behavior analysis information.

### CITATION LIST

### Patent Literature

[PLT 1] Japanese Laid-open Patent Publication No 2011-170565

### SUMMARY OF INVENTION

### Technical Problem

However, a customer in a store not only looks at a product while moving. For example, a customer stops to check a product. In other words, a person not only moves, but may also stop (or stay).

A behavior analysis system described in PTL 1 however, displays analyzed trajectory data of a person at the time of displaying an analyzed result of person's behavior in a target area. For this reason, there is a problem in that the behavior analysis system described in PTL 1 cannot appropriately display a result of behavior analysis of a person in the entire target area.

An object of the present invention is to provide an information-processing device, a data analysis method, and a recording medium, which can solve the above-described problem.

### Solution to Problem

An information-processing device according one aspect of the present invention includes: a person detection and tracking unit that receives analysis information including information related to positions of persons included in a target area, and calculates first person's-tracking-information that is time series information of the positions of the persons based on the analysis information; a same person detection unit that specifies the persons related to the first person's-tracking-information, classifies the first person's-tracking-information for each of the persons, and calculates second person's-tracking-information that is time series information of a position of each of the persons; a direction calculation unit that calculates movement direction information of each of the persons based on the second person's-tracking-information;

a staying time calculation unit that calculates staying-place information and staying-time information of each of the persons based on the second person's-tracking-information; and

a processing unit that calculates trajectory information and staying information of one or more of the persons based on the movement direction information, the staying-place information, and the staying-time information, and displays the trajectory information and the staying information so as to overlap an image of the target area.

A data analysis method according to one aspect of the present invention includes: receiving analysis information including information related to positions of persons included in a target area, and calculating first person's-tracking-information that is time series information of the positions of the persons based on the analysis information; specifying the persons related to the first person's-tracking-information, classifying the first person's-tracking-information for each of the persons, and calculating second person's-tracking-information that is time series information of a position of each of the persons; calculating movement direction information of each of the persons based on the second person's-tracking-information; calculating staying-place information and staying-time information of each of the persons based on the second person's-tracking-information; and calculating trajectory information and staying information of one or more of the persons based on the movement direction information, the staying-place information, and the staying-time information, and displaying the trajectory information and the staying information so as to overlap an image of the target area.

A computer readable non-transitory recording medium one aspect of the present invention embodying a program, the program causing a computer to perform: a method, the method comprising receiving analysis information including information related to positions of persons included in a target area, and calculating first person's-tracking-information that is time series information of the positions of the persons based on the analysis information; specifying the persons related to the first person's-tracking-information, classifying the first person's-tracking-information for each of the persons, and calculating second person's-tracking-information that is time series information of a position of each of the persons; calculating movement direction information of each of the persons based on the second person's-tracking-information; calculating staying-place information and staying-time information of each of the persons based on the second person's-tracking-information; and calculating trajectory information and staying information of one or more of the persons based on the movement direction information, the staying-place information, and the staying-time information, and displaying the trajectory information and the staying information so as to overlap an image of the target area.

### Advantageous Effects of Invention

According to the present invention, it is possible to produce an advantageous effect in that a result of behavior analysis in an entire target area is appropriately displayed.

### BRIEF DESCRIPTION OF DRAWINGS

FIG. 1 is a block diagram illustrating one example of a configuration of an information-processing device according to a first exemplary embodiment in the present invention.

FIG. 2 illustrates one example of display of the information-processing device according to the first exemplary embodiment.

FIG. 3 illustrates one example of another configuration of the information-processing device according to the first exemplary embodiment.

FIG. 4 is a block diagram illustrating one example of a configuration of an information-processing device according to a second exemplary embodiment.

FIG. 5 illustrates one example of display of the information-processing device according to the second exemplary embodiment.

### DESCRIPTION OF EMBODIMENTS

Next, exemplary embodiments of the present invention are described with reference to the drawings.

The respective drawings illustrate the exemplary embodiments of the present invention. The present invention is, however, not limited to the illustrations of the respective drawings. The same number is allocated to the same configurations in the respective drawings, and their repeated description may be omitted.

In the drawings used in the following description, a configuration of a part not related to the description of the present invention is omitted and may not be depicted in the drawings.

### First Exemplary Embodiment

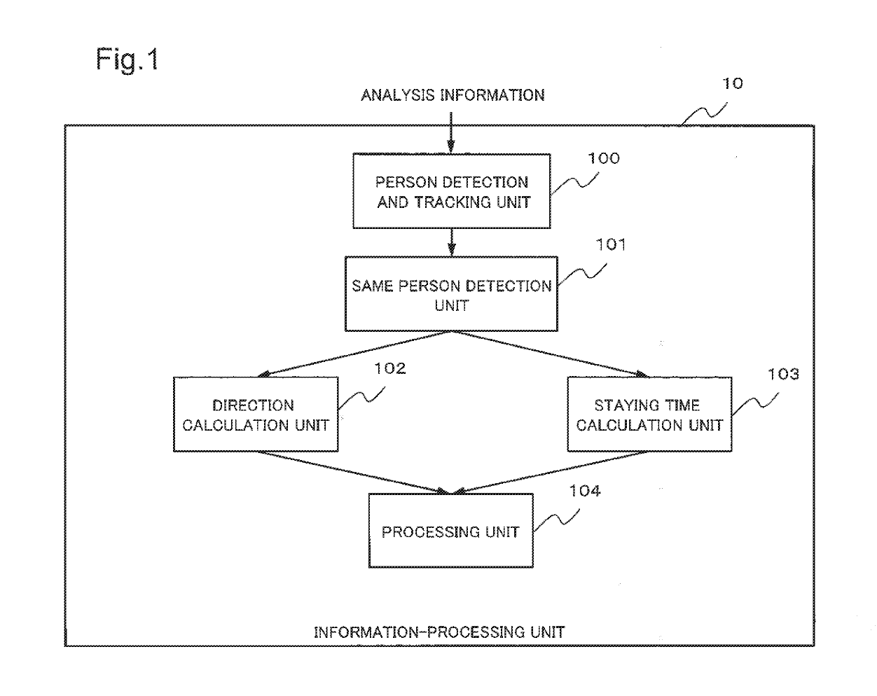

FIG. 1 is a block diagram illustrating one example of a configuration of an information-processing device 10 according to a first exemplary embodiment of the present invention. As illustrated in FIG. 1, the information-processing device 10 includes a person detection and tracking unit 100, a same person detection unit 101, a direction calculation unit 102, a staying time calculation unit 103, and a processing unit 104.

The person detection and tracking unit 100 receives analysis information used in analysis of behavior in a target area. The analysis information in the present exemplary embodiment is not particularly limited. The analysis information should include information related to a position. For example, the person detection and tracking unit 100 may receive an image of the floor (hereinafter referred to as “floor image”) from a camera capturing a designated floor that is a target area, as the analysis information. Alternatively, the person detection and tracking unit 100 may receive position information of a RFID tag, as the analysis information. In the following, as one example, description is made by using a floor image.

After receiving the floor image, the person detection and tracking unit 100 detects a position of a person or a plurality of positions of a plurality of persons from the floor image. For example, the person detection and tracking unit 100 may detect the position of the person by using a technique of image recognition (e.g., person image recognition).

Furthermore, the person detection and tracking unit 100 calculates time series information of positions of the persons by tracking positions of the persons among frames of the floor image. In the following, the time series information of positions of the persons calculated by the person detection and tracking unit 100 is referred to as “first person's-tracking-information”. The person detection and tracking unit 100 outputs the first person's-tracking-information to the same person detection unit 101. In the first person's-tracking-information, each person is not specified.

The same person detection unit 101 receives the first person's-tracking-information from the person detection and tracking unit 100. Then, the same person detection unit 101 specifies (detects) all persons included in the first person's-tracking-information. For example, the same person detection unit 101 may use a technique of face recognition for specifying. Furthermore, the same person detection unit 101 classifies the first person's-tracking-information for each of same persons distinguished as the same among the specified persons. In the following, the person's-tracking-information classified for each of the same persons by the same person detection unit 101 is referred to as “second person's-tracking-information”. The same person detection unit 101 detects time series information of positions of the same person, as the second person's-tracking-information. The same person detection unit 101 outputs the second person's-tracking-information to the direction calculation unit 102 and the staying time calculation unit 103. The same person detection unit 101 may specify all persons in a designated area. For example, when behaviors of customers are analyzed, the same person detection unit 101 may specify each customer except employees.

The direction calculation unit 102 receives the second person's-tracking-information from the same person detection unit 101. Then, based on time-sequentially continuous position information (in the person's-tracking-information) of each of the same persons, the direction calculation unit 102 calculates information indicating a movement direction (movement direction information) of the person (same person), as time series data. Then, the direction calculation unit 102 outputs the movement direction information calculated for each person to the processing unit 104.

The staying time calculation unit 103 receives the second person's-tracking-information from the same person detection unit 101. After the reception, based on the second person's-tracking-information, the staying time calculation unit 103 calculates staying-place information concerning a place where the same person stays, and staying-time information corresponding to a staying time length about the same person. Then, the staying time calculation unit 103 outputs the calculated staying-place information and the calculated staying-time information to the processing unit 104.

The processing unit 104 receives the movement direction information from the direction calculation unit 102, and receives the staying-place information and the staying-time information from the staying time calculation unit 103. Then, the processing unit 104 calculates trajectory information and staying information for each person based on the movement direction information, the staying-place information, and the staying-time information. The trajectory information is information concerning change of positions of each person. The staying information is information concerning staying of each person. The trajectory information and the staying information is information that the processing unit 104 uses for display. Thus, the trajectory information and the staying information may include information necessary for display, in addition to the above-described information.

Then, the processing unit 104 superimposes and displays an image of the calculated trajectory information and staying information on an image of the target area.

There are no limits to the number of persons of which information is displayed by the processing unit 104.

For example, the processing unit 104 may display the trajectory information and the staying information of all the persons. In this case, the information-processing device 10 displays the information concerning all the persons in the target area. Thus, a user of the information-processing device 10 can collectively grasp the travel information and the staying information of the persons in the entire target area.

Alternatively, the processing unit 104 may receive information of a target person to be displayed from an input device of a user of the information-processing device 10. In this case, the user of the information-processing device 10 can grasp the travel information and the staying information of the designated person in the entire target area. For example, the information-processing device 10 may display information of the persons whose ages are within a designated range.

There are no particular limits to display means by which the processing unit 104 displays the image. For example, the processing unit 104 may display the image on the display means, not illustrated, of the information-processing device 10. Alternatively, the processing unit 104 may send image information to an external device not illustrated.

In the present exemplary embodiment, there are no particular limits to a displaying form of the processing unit 104.

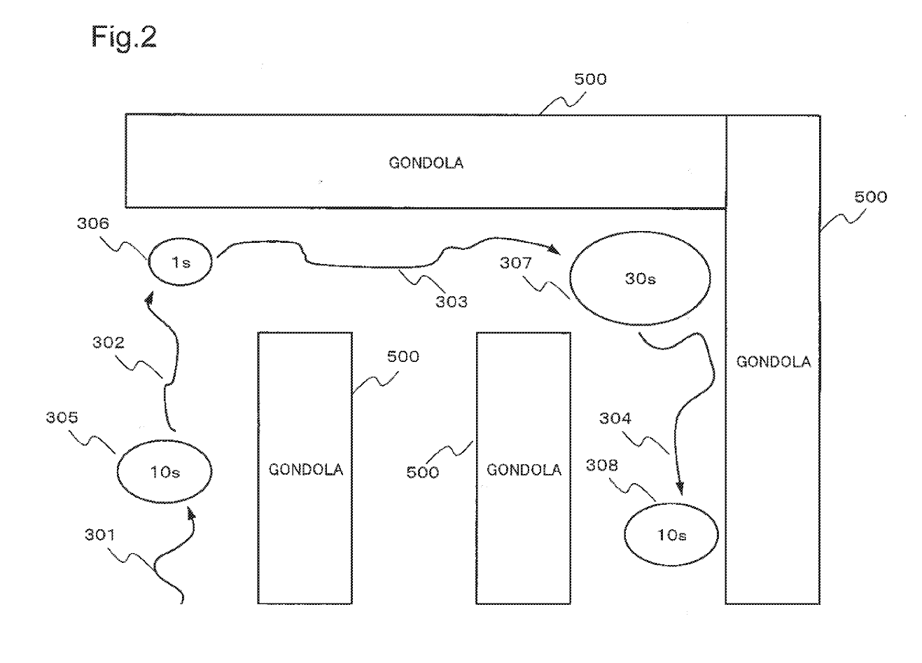

FIG. 2 illustrates one example of display of the processing unit 104.

FIG. 2 supposes a floor of a store, as one example of the target area. Accordingly, gondolas (display stands) 500 illustrated in FIG. 2 display products. A customer moves from the gondola 500 to the gondola 500 illustrated in FIG. 2. The information-processing device 10 receives floor images from a camera, not illustrated, installed in the store. Then, each configuration of the information-processing device 10 operates as described above.

As a result, the processing unit 104 calculates the trajectory information based on the received movement direction information of the person. Then, the processing unit 104 converts the calculated trajectory information into successive points of coordinates on the image (floor map) of the target area. Then, as illustrated in FIG. 2, the processing unit 104 displays the trajectory information of the person as the trajectory information 301, the trajectory information 302, the trajectory information 303, and the trajectory information 304.

Furthermore, the processing unit 104 calculates a staying place on the coordinates in the floor map based on the received staying-place information of the person. In addition, the processing unit 104 calculates a staying time length from the received staying-time information. Then, as illustrated in FIG. 2, the processing unit 104 displays the staying information 305, the staying information 306, the staying information 307, and the staying information 308 indicating the staying places and the staying time lengths. In FIG. 2, values indicated at the staying information 305 to 308 are staying time lengths.

The processing unit 104 in the present exemplary embodiment displays the staying information 305 to 308 as diagrams whose sizes are proportional to the staying time lengths. This proportion, however, does not need to be limited to mathematically strict proportion. The processing unit 104 should display diagrams corresponding to the staying time lengths. For example, the diagram of the staying information 306 corresponding to the staying time length of “1 s (1 second)” is smaller than the diagram of the staying information 305 corresponding to the staying time length of “10 s (10 seconds)”. For easy understanding of display, ratios between sizes of the diagrams and the staying time lengths may vary from a strict ratio.

Display by the processing unit 104 in the exemplary embodiment does not need to be limited to the display in FIG. 2. For example, the processing unit 104 may change a color of display, a size of a character, or a thickness of a line based on the staying time length.

Thus, the processing unit 104 in the present exemplary embodiment displays the staying information 305 to 308 indicating the staying places and the staying time lengths, in addition to the trajectory information 301 to 304 based on the movement information.

Next, advantageous effects of the present exemplary embodiment are described.

The advantageous effect obtained from the present exemplary embodiment is that a result of analysis of behavior in an entire target area is appropriately displayed.

The reason for it is as follows.

The person detection and tracking unit 100 in the present exemplary embodiment calculates the first person's-tracking-information by detecting positions of persons based on the analysis information. Then, the same person detection unit 101 classifies the first person's-tracking-information into each person. Then, the direction calculation unit 102 outputs the movement direction information for each of the classified persons. Meanwhile, the staying time calculation unit 103 outputs the staying-place information and the staying-time information. Then, the processing unit 104 can display the staying information based on the staying-place information and the staying-time information, as well as the trajectory information based on the movement direction information.

In other words, the present exemplary embodiment displays the trajectory information indicating the movement of the person, and the staying information indicating the staying of the person. Accordingly, an analyst who uses the information-processing device 10 of the present exemplary embodiment can simultaneously grasp the staying position and the staying time length as well as the movement of the person. For this reason, the analyst can perform more appropriate analysis.

Furthermore, in addition to the above-described advantageous effect, the advantageous effect that more detailed analysis of behavior of the person in the target area is appropriately displayed can be obtained from the exemplary embodiment.

This is because the processing unit 104 displays the trajectory information and the staying information of all or part of persons.

A store is used above for describing the present exemplary embodiment. Nevertheless, the present exemplary embodiment can be applied not only to a store, but also to an indoor floor such as a warehouse or an office, and an outdoor floor such as an amusement place.

### Modified Example

The above-described information-processing device 10 is configured as follows.

For example, each configuration unit of the information-processing device 10 may be configured by a hardware circuit.

The information-processing device 10 may be configured as a plurality of information-processing devices which are connected to each other via a network or a bus.

The information-processing device 10 may configure a plurality of units as one hardware.

The information-processing device 10 may be implemented as a computer device including a central processing unit (CPU), a read only memory (ROM), and a random access memory (RAM). The information-processing unit 10 may be configured as a computer device further including an input output circuit (IOC) and a network interface circuit (NIC) in addition to the above configuration.

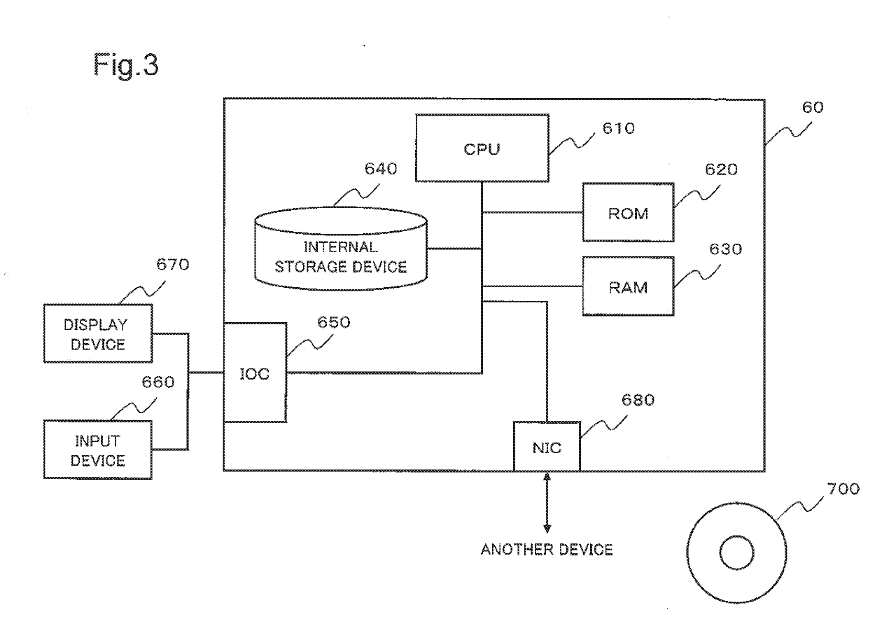

FIG. 3 is a block diagram illustrating one example of a configuration of an information-processing device 60 according to a modified example.

The information-processing device 60 includes a CPU 610, a ROM 620, a RAM 630, an internal storage device 640, an IOC 650, and an NIC 680 to constitute a computer.

The CPU 610 reads a program from the ROM 620. Then, based on the read program, the CPU 610 controls the RAM 630, the internal storage device 640, the IOC 650, and the NIC 680. Then, the computer including the CPU 610 controls these configurations to implement respective functions as the information-processing unit 10, illustrated in FIG. 1. The respective functions are functions of the person detection and tracking unit 100, the same person detection unit 101, the direction calculation unit 102, the staying time calculation unit 103, and the processing unit 104. At the time of implementing each function, the CPU 610 may use the RAM 630 or the internal storage device 640 as a temporary storage of the program.

The CPU 610 may use a storage medium reading device not illustrated, to read the program included in a computer readable storage medium 700 storing the program. Alternatively, the CPU 610 may receive the program from an external device, not illustrated, via the NIC 680. Further, the CPU 610 may store the read program or the received program in the RAM 630 to operate based on the stored program.

The ROM 620 stores the program executed by the CPU 610, and fixed data. The ROM 620 is a programmable-ROM (P-ROM) or a flash ROM, for example.

The RAM 630 temporarily stores the program executed by the CPU 610, and the data. The RAM 630 is a dynamic-RAM (D-RAM), for example.

The internal storage device 640 stores data and the program that the information-processing device 60 saves for a long period. The internal storage device 640 may operate as a temporary storage device of the CPU 610. The internal storage device 640 is a hard disk device, a magneto-optical disk device, a solid state drive (SSD), or a disk array device, for example.

The ROM 620 and the internal storage device 640 are non-transitory storage media. Meanwhile, the RAM 630 is a transitory storage medium. Then, the CPU 610 can operate based on the program stored in the ROM 620, the internal storage device 640, or the RAM 630. In other words, the CPU 610 can operate by using the non-transitory storage medium or the transitory storage medium.

The IOC 650 mediates data between the CPU 610 and an input device 660 and between the CPU 610 and a display device 670. The IOC 650 is an IO interface card or a universal serial bus (USB) card, for example.

The input device 660 is a device receiving input commands from an operator of the information-processing device 60. The input device 660 is a keyboard, a mouse, or a touch panel, for example. The input device 660 includes a camera outputting a floor image.

The display device 670 is a device displaying information to an operator of the information-processing device 60. The display device 670 is a liquid crystal display, for example. The CPU 610 may display on the display device 670 an image displayed by the processing unit 104. In this case, the display device 670 may be included in the processing unit 104.

The NIC 680 relays data communication with an external device, not illustrated, via a network. The NIC 680 is a local area network (LAN) card, for example.

The same advantageous effect as that of the information-processing device 10 can be obtained from the thus-configured information-processing device 60.

This is because the CPU 610 of the information-processing device 60 can implement the same functions as those of the information-processing device 10, based on the program.

### Second Exemplary Embodiment

Next, the exemplary embodiment 2 of the present invention is described with reference to the drawings.

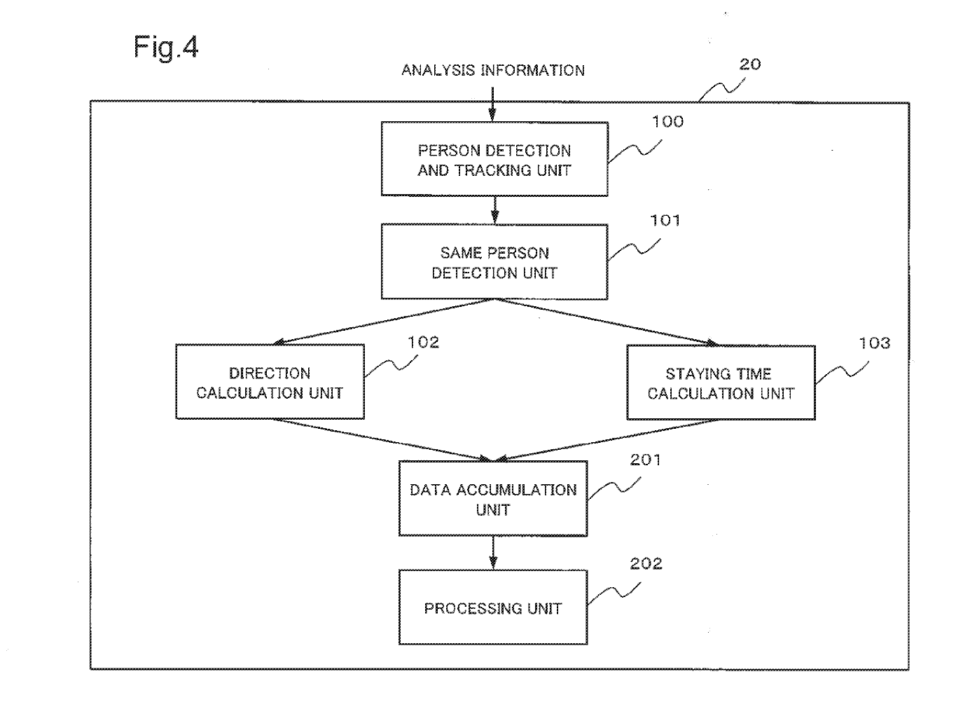

FIG. 4 is a block diagram illustrating one example of a configuration of an information-processing device 20 according to a second exemplary embodiment. As illustrated in FIG. 4, the information-processing device 20 includes the person detection and tracking unit 100, the same person detection unit 101, the direction calculation unit 102, the staying time calculation unit 103, a data accumulation unit 201, and a processing unit 202.

Since the person detection and tracking unit 100, the same person detection unit 101, the direction calculation unit 102, and the staying time calculation unit 103 are the same as those in the first exemplary embodiment, the detailed description is omitted. The following mainly describes the configuration and operation peculiar to the present exemplary embodiment.

The data accumulation unit 201 receives the movement direction information from the direction calculation unit 102, and receives the staying-place information and the staying-time information from the staying time calculation unit 103. Then, the data accumulation unit 201 accumulates the generated number of the persons of the movement direction information (trajectory data) of the same movement direction in the same section. Furthermore, the data accumulation unit 201 accumulates the generated number of the persons of the same staying place. The data accumulation unit 201 may hold, in advance, information of the section for which the number of the persons in the target area is accumulated. Alternatively, the data accumulation unit 201 may set the section for the accumulation, based on the staying-place information.

The data accumulation unit 201 outputs, to the processing unit 202, the accumulated number of the persons of the trajectory data of the same movement direction in the same section, and the accumulated number of the persons of the same staying place.

The processing unit 202 receives the accumulated number of the persons of the trajectory data of the same movement direction in the same section, and the accumulated number of the persons of the same staying place. Based on the received accumulated number of the persons of the trajectory data and the received accumulated number of the persons of the same staying place, the processing unit 202 superimposes and displays the trajectory information and the staying information on the image of the target area. In other words, the processing unit 202 displays the trajectory information and the staying information corresponding to the accumulated numbers of the persons.

The data accumulation unit 201 may accumulate one of the accumulated number of the persons of the trajectory data of the same movement direction in the same section and the accumulated number of the persons of the same staying place. In this case, the processing unit 202 may perform displaying based on the information accumulated by the data accumulation unit 201.

There are no particular limits to a displaying form of the processing unit 202.

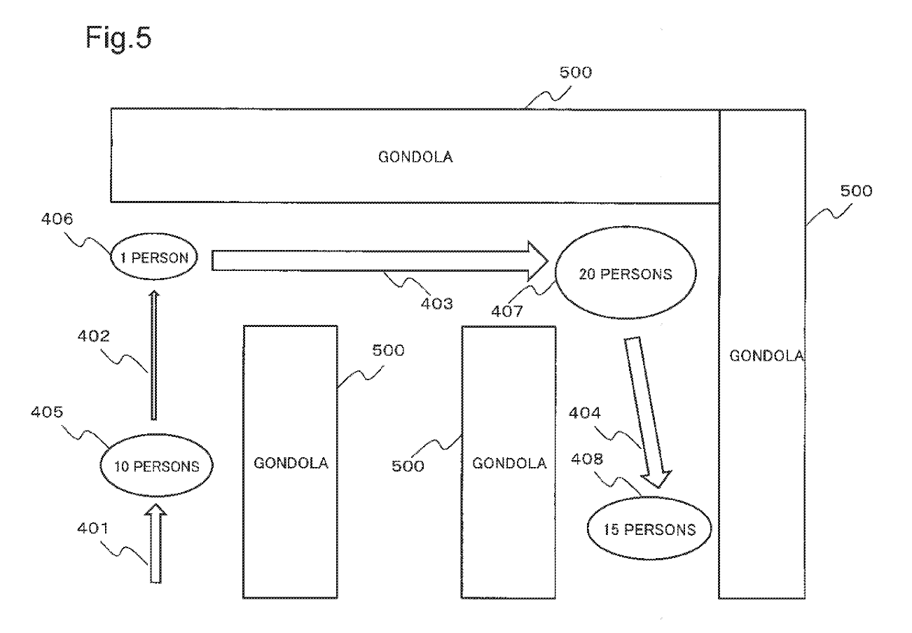

FIG. 5 illustrates one example of the displaying of the processing unit 202.

FIG. 5 supposes a floor of a store as in FIG. 2.

For example, the processing unit 202 displays as the displaying of the trajectory information the arrows whose thicknesses (widths) are proportional to the accumulated numbers of the persons. In FIG. 4, the trajectory information 401, the trajectory information 402, the trajectory information 403, and the trajectory information 404 are displayed.

In addition, the processing unit 202 displays as the displaying of the staying information the diagrams whose sizes are proportional to the accumulated number of the persons of the same staying place. In FIG. 4, the staying information 405, the staying information 406, the staying information 407, and the staying information 408 are displayed.

The proportion does not, however, need to be limited to mathematically strict proportion also in the present exemplary embodiment.

The display illustrated in FIG. 5 is further described.

For example, in FIG. 5, ten persons move along the trajectory indicated by the arrow of the trajectory information 401 to stay at the position indicated by the staying information 405. Similarly, one person moves along the trajectory indicated by the arrow of the trajectory information 402 to stay at the position indicated by the staying information 406. The trajectory information 401 and the staying information 405 is information corresponding to the ten persons. The trajectory information 402 and the staying information 406 is information corresponding to the one person. Accordingly, the trajectory information 401 is expressed by the arrow thicker than that of the trajectory information 402. Similarly, the staying information 405 is expressed by the diagram larger than that of the staying information 406.

The processing unit 202 may receive the movement direction information, the staying-place information, and the staying-time information in the same manner as the processing unit 104 of the first exemplary embodiment does, and display the same information that the processing unit 104 displays. In other words, the processing unit 202 may include the function of the processing unit 104. For example, the processing unit 202 may display information equivalent to the trajectory information 301 to 304 and the staying information 305 to 306, in addition to the trajectory information 401 to 404 and the staying information 405 to 406 corresponding to the accumulated numbers of the persons.

Next, advantageous effects of the present exemplary embodiments are described.

In addition to the advantageous effects of the first exemplary embodiment, the advantageous effect that the number of the persons related to the trajectory information and the staying information are clarified can be obtained.

The reason for it is as follows.

The data accumulation unit 201 of the present exemplary embodiment calculates the accumulated number of the persons of the trajectory data of the same direction in the same section and the accumulated number of the persons of the same staying place. Then, the processing unit 202 displays the trajectory information and the staying information corresponding to the accumulated numbers of the persons.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2014-034036, filed on Feb. 25, 2014, the disclosure of which is incorporated herein in its entirety by reference.

### REFERENCE SINGS LIST

10 Information-processing device
20 Information-processing device
60 Information-processing device
100 Person detection and tracking unit
101 Same person detection unit
102 Direction calculation unit
103 Staying time calculation unit
104 Processing unit
201 Data accumulation unit
202 Processing unit
301 Trajectory information
302 Trajectory information
303 Trajectory information
304 Trajectory information
305 Staying information
306 Staying information
307 Staying information
308 Staying information
401 Trajectory information
402 Trajectory information
403 Trajectory information
404 Trajectory information
405 Staying information
406 Staying information
407 Staying information
408 Staying information
500 Gondola
610 CPU
620 ROM
630 RAM
640 Internal storage device
650 IOC
660 Input device
670 Display device
680 NIC
700 Storage medium

1. An information-processing system comprising:
at least one processor; and
at least one memory storing executable instructions that, when executed by the at least one processor, cause the at least one processor to perform:
specifying movement direction of each of persons moving in a target area based on time series information of the positions of the persons within the target area; and
displaying a trajectory specified based on a first movement direction indicating a same direction in a same section in a predetermined time period based on the movement direction on an image of an area related to a position through that the person moves in the target area.

2. The information-processing system according to claim 1, wherein the instruction further cause the at least one processor to perform:
specifying a number of persons moving to the first movement direction; and
displaying the trajectory specified based on the number of the persons on an image of an area related to a position through that the person moves in the target area.

3. The information-processing system according to claim 1, wherein the instruction further cause the at least one processor to perform:
displaying the trajectory having a thickness according to the number of the persons of the same movement direction in the same section.

4. The information-processing system according to claim 3, wherein the thickness is proportional to the number of the persons of the same movement direction in the same section.

5. The information processing system according to claim 1, wherein the instruction further causes the at least one processor to perform:
specifying the trajectory for the person predetermined.

6. The information-processing system according to claim 5, wherein the predetermined person includes at least a customer.

7. The information-processing system according to claim 6, wherein the customer is specified by excepting employees.

8. The information processing system according to claim 1, wherein the instruction further causes the at least one processor to perform:
receiving information relating to at least one target person to be displayed from another device; and
displaying the trajectory for the target person.

9. The information-processing system according to claim 8, wherein the information relating to the target person is information specifying age of the target person.

10. The information processing system according to claim 9, wherein the information relating to the target person is information further specifying a range of the ages specified.

11. The information processing system according to claim 2, wherein the instruction further causes the at least one processor to perform:
setting a section for accumulating the number of persons in the target area based on the staying-place; and
accumulating the number of persons in the section.

12. The information-processing system according to claim 11, wherein the instruction further cause the at least one processor to perform:
displaying the trajectory having a thickness according to the accumulated number of the persons.

13. The information-processing system according to claim 12, wherein the thickness is proportional to the accumulated number of the persons of the same staying place in the same section.

14. An information-processing method comprising:
specifying movement direction of each of persons moving in a target area based on time series information of the positions of the persons within the target area; and
displaying a trajectory specified based on a first movement direction indicating a same direction in a same section in a predetermined time period based on the movement direction on an image of an area related to a positron through that the person moves in the target area.

15. The information processing method according to claim 14, further comprising:
specifying a number of persons moving to the first movement direction; and
displaying the trajectory calculated based on the number of the persons on an image of an area related to a position through that the person moves in the target area.

16. The information-processing method according to claim 14, further comprising:
displaying the trajectory having a thickness according to the number of the persons of the same movement direction in the same section.

17. The information-processing method according to claim 16, wherein the thickness is proportional to the number of the persons of the same movement direction in the same section.

18. A non-transitory computer-readable medium embodying a program, the program causing a computer to perform a method, the method comprising:
specifying movement direction of each of persons moving in a target area based on time series information of the positions of the persons within the target area; and
displaying a trajectory specified based on a first movement direction indicating a same direction in a same section in a predetermined time period based on the movement direction on an image of an area related to a position through that the person moves in the target area.

19. The medium according to claim 18, wherein the method further comprises:
specifying a number of persons moving to the first movement direction; and
displaying the trajectory calculated based on the number of the persons on an image of an area related to a position through that the person moves in the target area.

20. The medium according to claim 18, wherein the method further comprises:
displaying the trajectory having a thickness according to the number of the persons of the same movement direction in the same section.
